(19) United States
(12) Patent Application Publication
(10) Pub. No.: US 2024/0030468 A1
(43) Pub. Date: Jan. 25, 2024

(54) METHOD FOR OPERATING IN HOT STAND-BY MODE A SOFC FUEL CELL OR SOEC REACTOR

(71) Applicant: COMMISSARIAT A L'ENERGIE ATOMIQUE ET AUX ENERGIES ALTERNATIVES, Paris (FR)

(72) Inventors: Vincent LACROIX, Grenoble Cedex 09 (FR); Jerome AICART, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/256,872

(22) PCT Filed: Dec. 10, 2021
(86) PCT No.: PCT/EP2021/085206

§ 371 Date: Jun. 9, 2023

(30) Foreign Application Priority Data
Dec. 11, 2020 (FR) 2013059

(51) Int. Cl. H01M 8/043; H01M 8/04746; H01M 8/04223; H01M 8/04701; H01M 8/04007; H01M 8/1231; C25B 13/07; C25B 15/021

(52) U.S. Cl. CPC H01M 8/043; H01M 8/04746; H01M 8/04231; H01M 8/04701; H01M 8/04007; H01M 8/1231; C25B 13/07; C25B 15/021; H01M 2008/1293

(57) ABSTRACT

The invention relates to a method for operating in hot stand-by mode a fuel cell (SOFC) or a high-temperature electrolysis or co-electrolysis reactor (1), with a stack of solid oxide elementary electrochemical cells (SOEC), the method comprising, during a given period of absence of an electric current respectively flowing out of or applied to the stack or when it is sought to raise or lower the temperature of the cell or reactor, a step of supplying compartments on the side of the hydrogen/water electrodes (H2/H2O) with pulses of a safety gas at regular time intervals during the given period, or when the cell voltage drops below a threshold value, so as to renew the gas(es) present in said compartments.

### TECHNICAL FIELD

The present invention relates to the field of solid oxide fuel cells (SOFC), and that of high temperature electrolysis (HTE, or HTSE which stands for “High Temperature Steam Electrolysis”) of water or of CO₂, or the co-electrolysis of steam and carbon dioxide CO₂, and also solid oxide electrolysis cells (SOEC).

The invention concerns more particularly the operation of SOFC fuel cells or electrolysis or co-electrolysis reactors of the unit during a stoppage in production, that is to say with an output or input current of zero, and/or in the event of disconnection of the cell, in the event of a low level of available electricity, or in the event of insufficient access to the reactants, in a mode referred to as stand-by.

### PRIOR ART

The electrolysis of water is an electrolytic reaction which breaks down water into gaseous dihydrogen and dioxygen using an electric current in accordance with the following reaction:

H₂O→H₂+1/2O₂.

To perform electrolysis of water, it is advantageous to carry it out at high temperature, typically between 600° C. and 1000° C., since some of the energy required for the reaction can be supplied by heat, which is less expensive than electricity and the activation of the reaction is more effective at high temperature and does not require a noble metal catalyst. To implement high temperature electrolysis, it is known to use an electrolyser of SOEC (“Solid Oxide Electrolyte Cell” type, made up of a stack of elementary units each having a solid oxide electrolysis cell made up of at least three layers, anode/electrolyte/cathode, superposed on top of one another and interconnection plates made of metal alloys, also referred to as bipolar plates or interconnectors. The function of the interconnectors is to ensure both the passage of the electrical current and the circulation of the gases in the vicinity of each cell (steam injected, hydrogen and oxygen extracted in an HTE electrolyser; air and hydrogen injected and water extracted in an SOFC cell) and to separate the anode and cathode compartments, which are the compartments in which the gases circulate on the side of the anodes and cathodes, respectively, of the cells. To perform high temperature steam electrolysis, HTE, H₂O steam is injected into the cathode compartment. Under the effect of the current applied to the cell, disassociation of the molecules of water in steam form takes place at the interface between the hydrogen electrode (cathode) and the electrolyte: this disassociation produces dihydrogen gas, H2, and oxygen ions. The dihydrogen is collected and removed at the outlet of the hydrogen compartment. The oxygen ions, O²⁻, migrate through the electrolyte and recombine into dioxygen at the interface between the electrolyte and the oxygen electrode (anode).

As shown schematically in FIG. 1, each elementary electrolysis cell 1 is formed by a cathode 2 and an anode 4, which are placed on either side of a solid electrolyte 3 generally in the form of a membrane. The two electrodes (cathode and anode) 2, 4 are electron conductors made of porous material, and the electrolyte 3 is gastight, an electron insulator and an ion conductor. The electrolyte may in particular be an anion conductor, more specifically an anion conductor of the O²⁻ ions, and the electrolyser is then referred to as an anion electrolyser.

The electrochemical reactions take place at the interface between each of the electron conductors and the ion conductor.

At the cathode 2, the half-reaction is as follows:

2H₂O+4e⁻→2H₂+2O²⁻.

At the anode 4, the half-reaction is as follows:

2O²⁻→O₂+4e⁻.

The electrolyte 3 interposed between the two electrodes 2, 4 is the site of migration of the O²⁻, ions under the effect of the electrical field created by the difference in potential imposed between the anode 4 and the cathode 2.

The electrolysis of CO₂ acts on the same principle as that of water, except that the half-reaction at the cathode becomes:

2CO₂+4e^{-→}2CO+2O²⁻.

In cell mode, the half-reactions are reversed, but there are always O²⁻ ions migrating through the electrolyte.

As illustrated between parentheses in FIG. 1, the steam at the cathode inlet may be accompanied by hydrogen, H₂, and the hydrogen produced and recovered at the outlet may be accompanied by steam. Similarly, as illustrated in dashed line, a draining gas such as air can additionally be injected at the inlet to remove the oxygen produced. The injection of a draining gas has the additional function of acting as thermal regulator.

An elementary electrolysis reactor is made up of an elementary cell as described above, with a cathode 2, an electrolyte 3 and an anode 4, and of two monopolar connectors which provide the electrical, hydraulic and thermal distribution functions.

In order to increase the flow rates of hydrogen and oxygen that are produced, it is known to stack multiple elementary electrolysis cells on top of one another, separating them with interconnection devices, usually referred to as bipolar interconnection plates or interconnectors. The assembly is positioned between two end interconnection plates which bear the electrical supply means and gas supply means of the electrolyser (electrolysis reactor).

A high temperature water electrolyser (HTE) thus comprises at least one electrolysis cell, generally a plurality of electrolysis cells stacked on top of one another, each elementary cell being formed by an electrolyte, a cathode and an anode, the electrolyte being interposed between the anode and the cathode.

The fluidic and electrical interconnection devices, which are in electrical contact with one or more electrodes, generally provide the functions of introducing and collecting electrical current and delimit one or more chambers/compartments for the circulation of the gases. Thus, the function of a “cathode” compartment chamber is to distribute the electrical current and steam and also to recover the hydrogen at the cathode in contact.

The function of an “anode” compartment chamber is to distribute the electrical current and also to recover the oxygen produced at the anode in contact, optionally by means of a draining gas.

FIG. 2 shows an exploded view of elementary units of a high temperature steam electrolyser according to the prior art. This HTE electrolyser has a plurality of elementary electrolysis cells C1, C2, etc. of the solid oxide (SOEC) type, stacked alternately with interconnectors 5. Each cell C1, C2, etc. is made up of a cathode 2.1, 2.2, etc. and an anode 4.1, 4.2, between which an electrolyte 3.1, 3.2, etc. is disposed. The assembly of the electrolysis cells is supplied in series by the electrical current and in parallel by the gases. The interconnector 5 is a component made of a metal alloy, which provides the separation between the cathode compartment 50 and anode compartment 51, which are defined by the volumes between the interconnector 5 and the adjacent cathode 2.1 and between the interconnector 5 and the adjacent anode 4.2, respectively. It also ensures distribution of the gases among the cells. The injection of steam into each elementary unit takes place in the cathode compartment 50. The collection of the hydrogen produced and of the residual steam at the cathode 2.1, 2.2, etc. takes place in the cathode compartment 50 downstream of the cell C1, C2, etc. after dissociation of the steam by the latter. The collection of the oxygen produced at the anode 4.2 takes place in the anode compartment 51 downstream of the cell C1, C2, etc. after dissociation of the steam by the latter.

The interconnector 5 ensures the passage of the current between the cells C1 and C2 by way of contact, preferably direct contact, with the adjacent electrodes, that is to say between the anode 4.2 and the cathode 2.1.

In a solid oxide fuel cell, SOFC, the cells C1, C2, etc. and interconnectors 5 used are the same components, but the operation is the reverse of that of an HTE electrolyser as has just been explained, with a reversed current direction, with air or oxygen, O₂, which supplies the compartments that have become cathode compartments, and hydrogen and/or methane, CH₄, as fuel which supplies the compartments that have become anode compartments.

As regards the materials, the solid electrolyte is a material impermeable to gas, which should allow the diffusion of the oxygen atoms in the form of O²⁻ ions above 500° C.

Each electrode of an SOEC/SOFC cell, for its part, is made up of a usually porous cermet composed largely of silica and nickel on the hydrogen/H₂O side (cathode in (co-)electrolysis mode, anode in SOFC cell mode).

In order to operate, a cermet on the hydrogen/H₂O side should comprise nickel, which it includes in reduced form: this is because this reduced metal has the role of breaking the H—O bonds. However, the O²⁻ ions are able to migrate from the cermet on the air/O₂ side toward the cermet on the H₂ side through the electrolyte, even when there is no current.

It is also the case that the absence of current can often occur once the SOFC cells or HTE/SOEC electrolysis reactors or co-electrolysis reactors have been started up, more particularly for the latter in the event of possible intermittency in the production of electricity.

It has proven necessary to ensure that the temperature of the SOFC fuel cells or HTE/SOEC co-electrolysis or electrolysis reactors is maintained so as, on the one hand, to avoid excessively quick thermal cycling, which can damage them, and, on the other hand, to provide options in terms of quick start up as soon as electricity is available again for the HTE/SOEC reactors or in terms of utilizing the current produced for the cells. Such an operating mode is known by the term “stand-by” or “hot stand-by” mode.

Although the flow of O²⁻ ions mentioned above is low when there is zero current, a cell kept at working temperature, typically between 700° C. and 800° C., for a prolonged period of time can gradually see said flow oxidize its cermet on the H2 side.

In order to limit these risks of oxidation while still keeping an SOEC reactor or SOFC fuel cell in hot stand-by mode, that is to say kept at a high enough temperature to start up virtually instantaneously, the most widespread method consists in flushing the chambers on the H₂/H₂O side with a continuous flow of hydrogen, either pure or diluted in an inert gas. For safety and cost reasons, safety gases at approximately 5% H2 in nitrogen tend to be preferred. The safety gas can either be provided from a container or produced on site via a dedicated electrolysis reactor and/or an air separation unit (ASU), which notably produces oxygen, nitrogen and noble gases of high purity.

However, this continuous flushing with safety gas involves costs in terms of:
materials implemented: a safety gas can be recycled and circulate in a loop, but it needs to be purged upon each start-up to avoid contaminating the hydrogen produced;
electrical consumption: the gas must be made to move, notably by means of a circulator;
thermal consumption: the safety gas must be preheated before it arrives in the high-temperature chamber that is an SOEC reactor or SOFC fuel cell, in order not to cool the latter down.

Other solutions, as alternatives to the flow of safety gas, are known from the literature. For example, U.S. Pat. No. 9,005,827 B2 describes a method in which each cell is kept in operation at a low current applied with a cell voltage ranging from 700 to 1500 mV, in order to prevent the reoxidation of the nickel Ni into NiO.

Patent JP 2626395 B2 also proposes the periodic use of an SOFC cell in electrolysis mode in order to reduce the cermets which can be partially oxidized when it is operating, thereby prolonging the service life of the cell.

By contrast, it is also known to reverse the operation of an SOEC or co-electrolysis reactor, that is to say to operate it in SOFC fuel cell mode, to produce current from hydrogen H2, syngas (mixture of hydrogen H2 and carbon monoxide CO), or methane, this making it possible to maintain the temperature of the reactor. This has the major drawback of producing electrical current which is not necessarily recoverable, since there is no longer electricity available from external sources. Moreover, another major drawback is that fuel, i.e. Hz, syngas or methane, is thus consumed, that is to say burned, solely for the purposes of maintaining the temperature of the reactor and without obtaining another combustible product, but solely electricity, which is not necessarily recoverable at the present time. Patent application US 2003/0235752 proposes the arrangement of getter materials, such as nickel, which are able to react with traces of oxygen in the flow entering the hydrogen compartment such that these materials are oxidized instead of the cermets. This solution can make it possible to perform flushing with virtually pure nitrogen (without H₂), since the traces of oxygen that are still present are captured by the added material(s). Such a flushing gas (pure nitrogen) has the advantage of being less expensive, but its implementation would not solve the problem of migration of the O²⁻ ions into the electrolyte or the energy consumption of the flushing gas owing to the use of a compressor and the need for preheating.

There is therefore a need to improve the existing solutions for staying in hot stand-by mode while still limiting the risks of oxidation of an SOEC reactor or an SOFC fuel cell, notably in order to overcome the aforementioned drawbacks.

The aim of the invention is to at least partly meet this need.

### DESCRIPTION OF THE INVENTION

To do this, the invention relates to a method for operating, in hot stand-by mode, a fuel cell (SOFC) or a high temperature co-electrolysis or electrolysis reactor having a stack of elementary electrochemical cells of the solid oxide type (SOEC), the method comprising, for a given period of time in which there is no electrical current exiting and/or applied to the stack, or when the temperature of the cell or the reactor is to be raised or lowered, a step of supplying pulses of a safety gas to the compartments on the side of the hydrogen/water (H₂/H₂O) electrodes, at regular intervals for the given period of time or when the cell voltage drops below a threshold value, so as to renew the gas(es) present in said compartments. Here and within the context of the invention, “hot stand-by mode” is understood to mean keeping an SOFC fuel cell or an SOEC electrolysis reactor at a normal operating temperature, typically from 700° C. to 800° C., during a stoppage in operation owing to the absence of current at the outlet (cell) or inlet (SOEC reactor).

The safety gas is advantageously selected from among pure hydrogen (H₂), and hydrogen (H₂) diluted in nitrogen, preferably diluted from 1% to 5% by volume in nitrogen. Hydrogen (H₂) diluted to approximately 3% by volume in nitrogen is optimal.

Advantageously, the voltage of the stack(s) is monitored. If the cell voltage exceeds 0.8 V or a lower value, a pulse of gas will be delivered. In other words, the step of supplying pulses of safety gas is performed advantageously for a cell voltage threshold value less than or equal to 0.8 V.

Also advantageously, the flow rate of pulses of safety gas is less than or equal to less than 10 NmL/min/cm², preferably less than 5 NmL/min/cm². Typically, it is about 6 NmL/min/cm².

The flow rate, the interval and the duration of the pulses will depend on the configuration of the installation, and the ratio of volume/distance between the cell stacks and the measurement and control units. The profile of the pulses (ramps between zero flow rate and maximum flow rate) can advantageously also vary depending on the model of the stacks and the configuration of the supply lines, in order to limit the effects of “water hammer”, which can be detrimental to the electrochemical system.

According to an advantageous variant, when no pulses of safety gas are supplied to the compartments on the side of the hydrogen/water (H₂/H₂O) electrodes, all the gas supply lines of the reactor or the fuel cell are closed so as to limit the cooling of the reactor or fuel cell via the movement of gas.

According to an advantageous embodiment, at the same time as or with a temporal shift from the pulsing of safety gas, the compartments on the side of the oxygen (O₂) electrodes are purged using a neutral gas or a greatly oxygen-depleted gas. This reduces or even eliminates the flow of O²⁻ ions sent toward the electrolyte via a reduction in the partial pressure of the oxygen.

According to an advantageous variant, in order to compensate the thermal losses by convection through the chamber which houses the SOEC reactor or the SOFC fuel cell, at the same time as the pulses of safety gas, the stack is heated to maintain its temperature. According to this variant, the stack is heated using a heating baseplate in contact with the stack.

The method according to the invention may be advantageously implemented in a unit, referred to as power-to-gas unit, comprising a plurality of reactors (SOEC).

As a result, the invention consists essentially in delivering, in a solid oxide electrochemical cell system (SOEC reactor or SOFC fuel cell) which is in hot stand-by mode, a safety gas to the H₂/H₂O compartments/chambers intermittently at regular intervals.

By thus regularly renewing the gas present with an appropriate safety gas, the risk of oxidation of the cermets of the hydrogen electrodes is eliminated.

Using an intermittent flow of safety gas moreover has the effect of eliminating the cooling by convection of the gas in the chamber in which the reactor/SOFC fuel cell is placed. The thermal losses via the hot chamber can be compensated by heating the chamber itself or directly by heating the stack of cells, notably by means of a heating baseplate in contact with the stack.

The frequency of flushing with safety gas and its quantity (flow rate, duration) should be set as a function of the electrochemical system implemented. More particularly, the setting of these can be done:
depending on the type and manufacturer of the cells, which directly impacts the flow of O²⁻ ions liable to migrate: this can be variable, since it depends on the various thicknesses of the layers making up a cell (cermets on H₂ and O₂ side, electrolyte);
depending on the partial pressure of O₂ on the side of the O₂ circulation compartments: the higher the partial pressure of the compartment is and the more easily oxidized the cermet on the O₂ side is, this increasing the driving force of creation of O²⁻ ions at the O₂ cermet/electrolyte interface;
the volume of the pipework from the reservoir/circulator of safety gas: the greater the distance to be traveled is and the greater the volume this represents is, and the greater the extent to which it is necessary to inject gas in order to renew the atmosphere of a stack of electrochemical cells;
the concentration of reducing agent, notably hydrogen, in the safety gas: the greater the reducing effect of this gas, the smaller the volume necessary to renew the reducing atmosphere of a stack can be.

Lastly, the invention affords many advantages, among which mention may be made of:
reducing the energy cost by consuming just enough safety gas to avoid any oxidation of the cermets of an SOFC fuel cell or an SOEC reactor;
minimal loading of the hardware required to supply the safety gas and thus a longer service life combined with a low investment cost.

Further advantages and features of the invention will become more clearly apparent from reading the detailed description of implementation examples of the invention, which is given by way of non-limiting illustration with reference to the following figures.

### BRIEF DESCRIPTION OF THE DRAWINGS

FIG. 1 is a schematic view showing the operating principle of a high temperature water electrolyser.

FIG. 2 is a schematic exploded view of part of a high temperature steam electrolyser comprising interconnectors.

### DETAILED DESCRIPTION

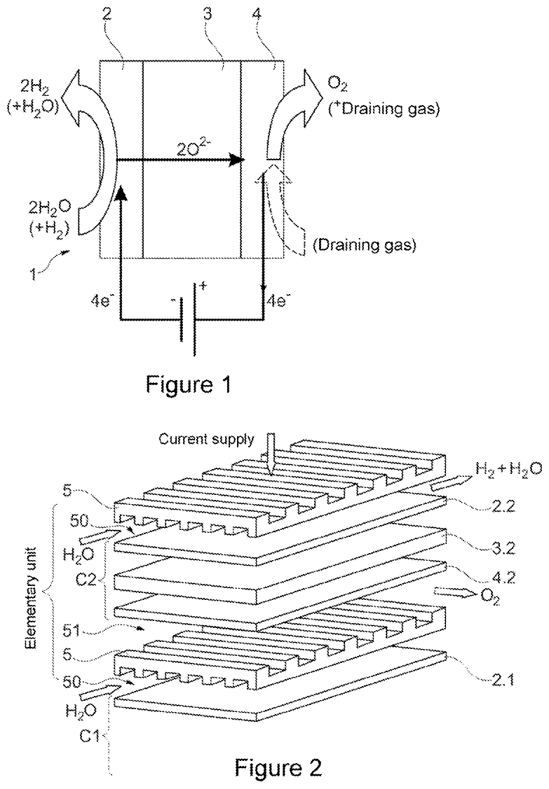

FIGS. 1 and 2 have already been commented upon in the preamble. They will therefore not be described below.

It is also specified that the electrolysers or fuel cells described are of the solid oxide type (SOEC, which stands for “Solid Oxide Electrolyte Cell”, or SOFC, which stands for “Solid Oxide Fuel Cell”) operating at high temperature. As a result, all the constituent parts (anode/electrolyte/cathode) of an electrolysis cell or stack are ceramics. The high operating temperature of an electrolyser (electrolysis reactor) or a cell is typically between 600° C. and 1000° C. Typically, the features of an SOEC electrolysis cell in accordance with the invention, of the cathode-supported (CSC) type, can be those indicated as follows in table 1 below.

TABLE 1

| Electrolysis cell | Unit | Value |
|---|---|---|
| Cathode 2 | | |
| Constituent material | | Ni-YSZ |
| Thickness | μm | 315 |
| Thermal conductivity | W m⁻¹ K⁻¹ | 13.1 |
| Electrical conductivity | Ω⁻¹ m⁻¹ | 10⁵ |
| Porosity | | 0.37 |
| Permeability | m³ | 10⁻¹³ |
| Tortuosity | | 4 |
| Current density | A · m⁻² | 5300 |
| Anode 4 | | |
| Constituent material | | LSM |
| Thickness | μm | 20 |
| Thermal conductivity | W m⁻¹ K⁻¹ | 9.6 |
| Electrical conductivity | Ω⁻¹ m⁻¹ | 1 10⁴ |
| Porosity | | 0.37 |
| Permeability | m² | 10⁻¹³ |
| Tortuosity | | 4 |
| Current density | A · m⁻² | 2000 |
| Electrolyte 3 | | |
| Constituent material | | YSZ |
| Thickness | μm | 5 |
| Resistivity | Ω m | 0.42 |

According to the invention, when an SOEC reactor or an SOFC fuel cell is in hot stand-by mode, a safety gas is delivered to the H₂/H₂O compartments/chambers intermittently at regular intervals.

The safety gas is advantageously hydrogen (H₂) diluted to approximately 3% by volume in nitrogen.

Advantageously, the voltage of the stack(s) is monitored. If the cell voltage exceeds 0.8 V or a lower value, a pulse of safety gas is delivered.

Typically, the flow rate of pulses of safety gas is about 6 NmL/min/cm².

The invention is not limited to the examples that have just been described; features of the illustrated examples may in particular be combined together within variants that are not illustrated.

Further variants and improvements may be envisaged without departing from the scope of the invention.

1. A method for operating, in hot stand-by mode, a fuel cell (SOFC) or an electrolysis reactor for high temperature co-electrolysis or electrolysis having a stack of elementary electrochemical cells of the solid oxide type (SOEC), the method comprising, for a given period of time in which there is no electrical current exiting and/or applied to the stack, or when the temperature of the cell or the reactor is to be raised or lowered, supplying pulses of a safety gas to compartments on a side of hydrogen/water (H₂/H₂O) electrodes, the pulses being supplied at regular intervals for the given period of time, or when the cell voltage drops below a threshold value, wherein the pulses are supplied to renew a gas present in the compartments.

2. The method of claim 1, wherein the safety gas is at least one selected from the group consisting of pure hydrogen (H₂), and hydrogen (H₂) diluted in nitrogen.

3. The method of claim 1, wherein the supplying pulses of safety gas is performed for a cell voltage threshold value less than or equal to 0.8 V.

4. The method of claim 1, wherein a flow rate of pulses of safety gas is less than 10 NmL/min/cm².

5. The method of claim 1, wherein, when no pulses of safety gas are supplied to the compartments on the side of the hydrogen/water (H₂/H₂O) electrodes, all gas supply lines of the electrolysis reactor or the fuel cell are closed so as to limit the cooling of the reactor or fuel cell via the movement of gas.

6. The method of claim 1, further comprising, at the same time as or with a temporal shift from the pulsing of safety gas, purging compartments on a side of oxygen (O₂) electrodes using at least one gas selected from the group consisting of a neutral gas or a greatly oxygen-depleted gas.

7. The method of claim 1, further comprising, at the same time as the pulsing of safety gas, heating the stack to maintain a stack temperature.

8. The method of claim 7, wherein the stack is heated using a heating baseplate in contact with the stack.

9. The method of claim 1, implemented in a power-to-gas unit, comprising a plurality of electrolysis reactors having a stack of elementary electrochemical cells of the solid oxide type (SOEC).

10. The method of claim 2, wherein the hydrogen (H₂) diluted in nitrogen comprises 1% to 5% hydrogen by volume.

11. The method of claim 1, wherein a flow rate of pulses of safety gas is less than 5 NmL/min/cm².
